(19) United States
(12) Patent Application Publication
(10) Pub. No.: US 2010/0281878 A1
(43) Pub. Date: Nov. 11, 2010

(54) MILD GASIFICATION COMBINED-CYCLE POWERPLANT

(75) Inventor: Alex Wormser, Marblehead, MA (US)

Correspondence Address: MCCARTER & ENGLISH, LLP BOSTON, 265 Franklin Street, Boston, MA, 02110, US

(73) Assignee: WORMSER ENERGY SOLUTIONS, INC., Marblehead, MA (US)

(21) Appl. No.: 12/664,639

(22) PCT Filed: Jun. 13, 2008
(86) PCT No.: PCT/US08/67022

§ 371 Date: Jul. 26, 2010

Related U.S. Application Data
(60) Provisional application No. 60/943,808, filed on Jun. 13, 2007.
(60) Provisional application No. 60/979,468, filed on Oct. 12, 2007.

(51) Int. Cl. F02C 3/28; B01D 53/64; F23B 99/00

(52) U.S. Cl. 60/781; 110/342

(57) ABSTRACT

The invention provides a hybrid integrated gasification combined cycle (IGCC) plant for carbon dioxide emission reduction and increased efficiency where the syngas is maintained as a temperature above a tar condensation temperature of a volatile matter in the syngas. The invention also provides methods and equipment for retrofitting existing IGCC plants to reduce carbon dioxide emissions, increase efficiency, reduce equipment size and/or decrease the use of water, coal or other resources.

### RELATED APPLICATIONS

This application is related and claims priority to U.S. Provisional Application Ser. No. 60/943,808, filed Jun. 13, 2007, and U.S. Provisional Application Ser. No. 60/979,468, filed Oct. 12, 2007. The entire contents of these applications are explicitly incorporated herein by this reference.

### BACKGROUND

There are two current trends related to clean coal powerplants: hybrid integrated gasification combined cycle (IGCC) technology and the retrofitting of existing pulverized coal (PC) plants to reduce their CO₂ emissions.

With regard to Hybrid IGCCs, the first generation IGCCs use oxygen-blown gasifiers, while the second generation IGCCs use air blown gasification. Both of these IGCCs attempted to gasify as much of the coal as possible. Third generation IGCCs utilize a carbonizer rather than a gasifier, and gasify only a portion of the coal, leaving a residue of char. The char is then burned in a combustor to provide additional power. Various terms have been used interchangeably to describe the third generation of IGCC technology including: mild gasification, partial gasification, and hybrids.

With regard to retrofitting existing coal-fired steamplants with IGCCs, policy studies by the U.S. government's National Energy Management Systems (NEMS) reflect the increasing awareness of both the importance, and the unique difficulty, of reducing CO₂ emissions from the existing fleet of PC plants. Coal powerplants produce a quarter of the world's CO₂ emissions, and thus can't be ignored in any program that seeks to significantly reduce the world's emissions. Conventional low-emission technologies, such as wind and nuclear technologies, affect only new capacity, so the problem with the existing PC emissions remains. Tearing the plants down is economically unfeasible; the other option is to retrofit them with IGCCs that also provide for CCS, which is also economically unfeasible.

One conclusion of the NEMS studies is that CO₂ emissions from PC plants in the United States could be reduced by as much as 80% by the year 2030, if the right financial conditions are met. For this to be economically viable however, the cost of IGCCs would have to drop significantly, and sufficiently costly carbon caps would have to be imposed.

### SUMMARY

The present invention is based, at least in part, on a clean-coal technology, which employs both hybrid IGCC technology and the retrofitting of existing PC plants, alone or in combination. (See, e.g., FIG. 1).

In one aspect, the invention provides a hybrid integrated gasification combined cycle (IGCC) plant for carbon dioxide emission reduction and increased efficiency. The hybrid IGCC includes a carbonizer that forms a syngas, a syngas cooler, a warm gas cleanup system, and a gas turbine fired by the syngas. The hybrid IGCC plant operates such that the syngas is maintained as a temperature above a tar condensation temperature of a volatile matter in the syngas. In some embodiments, the syngas is formed from a solid fuel such as coal. Additionally or alternatively, biomass may be employed.

In some embodiments, the carbonizer heats incoming flows with at least one external burner.

In some embodiments, char from the hybrid plant is burned in a steamplant. Additionally, in some embodiments, a flue gas from the gas turbine is ducted to the steamplant in order to recover its heat and convert it to electrical power by a steam turbine generator. In some embodiments, both the char and a portion of the syngas are ducted to the existing steamplant. In some embodiments, additional air is added to the combustion chamber of said steamplant. A heat recovery steam generator supplements the heat recovery of said existing steamplant in some embodiments.

In some embodiments, the hybrid IGCC plant is modified to provide carbon capture and storage, in which the syngas leaving the warm gas cleanup system passes, in sequence, through an array of pressurized vessels comprising, in sequence, a partial oxidizer, a syngas cooler, a water-gas shift reactor, and an absorption system for separating carbon dioxide from the gaseous fuel, whereby said carbon dioxide is then dried and compressed before being sequestered.

In some embodiments, the carbonizer comprises a spouted fluidized bed within a pressure vessel, said spouted bed incorporating a draft tube. In further embodiments, the carbonizer comprises a distributor plate that feeds steam and air to an annular space surrounding the draft tube and means for feeding coal to and removing excess char from the carbonizer.

In some embodiments, the syngas cooler comprises a fluidized bed containing coolant tubes.

In some embodiments, a waste heat from the syngas cooler is reinjected into the syngas or a steam stream or both.

In some embodiments where coal is employed, the coal is dried and heated before being injected into the carbonizer, using a precombustion thermal treatment of coal (PCTTC) system. In some embodiments, a coal dryer is included that includes an atmospheric-pressure dual-stage fluidized bed combustor, wherein combustion occurs in a lower fluidized bed, the lower fluidized bed incorporating coolant tubes to maintain its temperature below a fusion temperature of the ash in the fuel, and wherein one or more products of combustion from the lower fluidized bed pass through a distributor plate overhead and into a second fluidized bed, the second fluidized bed containing the coal being dried. In some embodiments, coolant entering the coolant tubes comes from an acid plant in the IGCC plan, wherein some of the coolant emerging from the lower bed cooling tubes is directed at a steam turbine, and the remainder of the coolant is ducted to a coal heater of the PCTTC system, and wherein the coolant emerging from the coal heater is pumped back to the entrance of the coolant tubes in the lower fluidized bed of the combustor.

In some embodiments, the syngas cooler comprises a distributor plate comprising a plurality of slanted tubes mounted on a fin-tube plate assembly, wherein the slanted tubes are mounted on a slant sufficient to eliminate the weepage of a bed material when the IGCC plant is not operating.

In some embodiments, a fluidized bed of a char in the carbonizer is divided into segments each independently fed by a mixture of steam and air, and the IGCC plant efficiency is maintained during a diminishment of a coal feed by use of additional segments to gasify char during the diminishment of the coal feed.

In some embodiments, particulates containing calcium carbonate are injected onto a distributor plate included in a carbonizer bed in the carbonizer.

In some embodiments, char, e.g., char leaving the carbonizer and/or a char cooler, is pulverized, and the pulverized char is passed over a separator, in order to remove fine particles of ash that also contain mercury. In some embodiments, the separator employs either magnetic forces or electrostatic forces, or both, to separate the ash from the char.

In some embodiments, the gasification level is at least about 70%, preferably at least about 75%, more preferably at least about 80%, more preferably at least about 85%, more preferably at least about 90%, more preferably at least about 95%. In some embodiments, the syngas has a heating value of about 300 BTU/SCF or more. In others the syngas has a heating value of about 350 BTU/SCF or more, about 400 BTU/SCF or more, about 450 BTU/SCF or more, or about 500 BTU/SCF or more. In some embodiments, the syngas is maintained at a temperature of about 900° F. or more, about 950° F. or more, about 1000° F. or more, about 1100° F. or more, or about 1200° F. or more. In some embodiments, the carbon conversion ratio is about 80% or more.

In another aspect, the invention provides a method of retrofitting an existing IGCC plant comprising the step of retrofitting an existing IGCC plant to provide an IGCC plant according to any one of the preceding claims.

In yet another aspect the invention provides methods of reducing carbon dioxide emissions and/or increasing efficiency and/or reducing equipment size and/or decreasing the use of water, coal or other resources (e.g., in comparison to other coal-fired power plants), employing the steps described herein.

### BRIEF DESCRIPTION OF THE DRAWINGS

FIG. 1 is a series of tables comparing exemplary hybrid IGCCs in accordance with the present invention with oxygen-blown IGCCs, other air blown IGCCs and other hybrid IGCCs.

FIGS. 2 and 3 are flow diagrams which depict exemplary configurations of IGCCs in accordance with the present invention.

FIG. 4 is a diagram which depicts an exemplary process flow in accordance with the present invention.

FIG. 5 is a diagram which depicts an exemplary carbonizer in accordance with the present invention.

FIGS. 6A, 6B and 6C are diagrams which respectively depict the top view, elevation view and side cross-sectional view of an exemplary distributor plate for cooling or desulfurizing syngas in accordance with the present invention.

FIGS. 7A and 7B are diagrams which respectively depict (A) an exemplary portion of a carbonizer in accordance with the present invention modified for turndown and (B) the cross section of such carbonizer along the “A” line of FIG. 7A, to depict an exemplary annular bed.

FIG. 8 is a diagram of an exemplary coal preparation system in accordance with the present invention.

FIG. 9 is a diagram of an exemplary char preparation system in accordance with the present invention.

FIG. 10 is a flow diagram which depicts an exemplary configuration of an IGCC in accordance with the present invention.

FIG. 11 is a diagram of an exemplary in-bed desulfurizer in accordance with the present invention.

FIG. 12 is a diagram of an exemplary hybrid IGCC in accordance with the present invention which includes a CCS.

FIG. 13 is a table describing operating conditions in an exemplary gas turbine utilized in accordance with the present invention.

FIG. 14 is a table describing conditions in an exemplary carbonizer utilized in accordance with the present invention.

FIG. 15 is a graph depicting the plant efficiency of an exemplary hybrid IGCC in accordance with the present the invention as compared to other IGCCs.

FIG. 16 is a graph depicting the effect of an existing steamplant's efficiency on the efficiency of a combined system.

FIG. 17 is a table describing the size and operating parameters of three designs of gasifiers or carbonizers supplying syngas to similarly-rated IGCCs.

FIG. 18 is a table describing the size and operating parameters of two coolers, including an exemplary syngas cooler of the present invention.

FIG. 19 is a table describing typical contaminants of plants and methods for removal in accordance with the present invention.

FIG. 20 is a table describing the efficiency of four plant designs, including one in accordance with the present invention.

FIG. 21 is a graph depicting water consumption of seven plant designs, including two in accordance with the present invention.

FIGS. 22 and 23 are flow diagrams which depict exemplary configurations of IGCCs in accordance with the present invention.

FIGS. 24A and 24B are tables describing the flow, temperature and pressure in various portions of an exemplary IGCC in accordance with the present invention.

FIG. 25 is a table comparing various characteristics of airblown carbonizers, airblown gasifiers and oxygen blown gasifiers.

FIG. 26 is a table describing the airflow to gasifier and syngas flow rates of an exemplary IGCC in accordance with the present invention and a conventional IGCC.

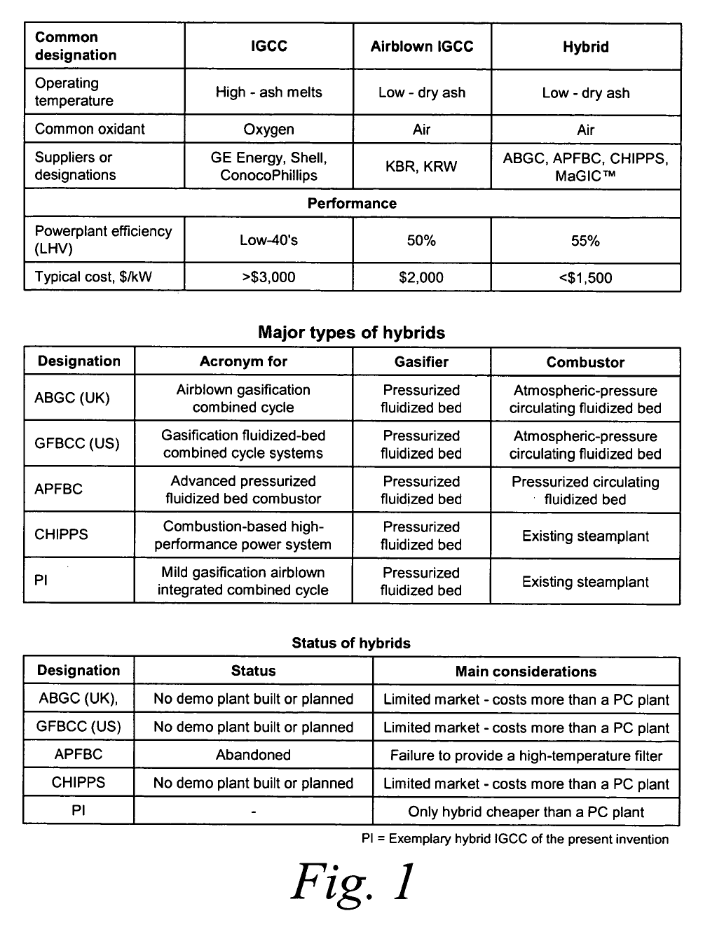

### DETAILED DESCRIPTION OF THE INVENTION

The present invention is based, at least in part, on a clean-coal technology. Without wishing to be bound by any particular theory, it is believed that the present invention will generate new power more cheaply than current technology and/or will reduce the carbon dioxide (CO₂) emissions from both new and existing coal-fired powerplants by 20-35% without carbon capture and storage (CCS), and upwards of 90% with CCS. In some embodiments, the present invention is used to retrofit existing powerplants of any type or fuel, or be used as a stand-alone new plant. In some embodiments, when used to retrofit, the present invention uses substantially less cooling water than a new freestanding plant would, regardless of the fuel.

In some embodiments, the present invention provides a hybrid IGCC plant. As used herein, the term “hybrid IGCC plant” is used interchangeably with “hybrid plant” and “hybrid IGCC” to refer to a plant which produces both syngas to fire a gas turbine, and char to fire an existing steamplant. In some embodiments, some or all of the char is used for other purposes, for example, to manufacture char briquettes.

Hybrid IGCC plants differ from other hybrid IGGCs by retaining the volatiles in coal as a fuel. As used herein, the terms “volatiles” and “volatile matter” are used interchangeably to refer to mixtures of hydrocarbon gases and vapors, as well as other (non-fuel) gases. The hydrocarbon vapors are called tars, in reference to their appearance when they condense.

Typically, tars remain vaporized as long as syngas is maintained above a maximum condensation temperature, e.g., above about 900° F. Previous hybrids used low-temperature gas cleanup systems, which operate below the condensation temperature of tar. Thus their gasifiers needed to destroy the tars to avoid fouling in the syngas cleanup system. In some embodiments, volatiles refer to medium-BTU fuels, e.g., about 500 BTU/SCF, with about four times the heating value of the syngas emerging from conventional air blown gasifiers.

Previous IGCCs required removal of the volatiles because their lower-temperature cleanup systems operate below the volatiles' condensation temperature. Volatiles from coal typically have density of about 500 BTU/SCF, whereas syngas from conventional airblown gasifiers typically have density of about 135 BTU/SCF. Warm-gas cleanup systems for syngas have recently been developed, which operate above the volatiles' condensation temperature. In some embodiments, the present invention employs a warm-gas cleanup system (WGCU), which operates above the tar condensation point of volatiles in the syngas. In some embodiments, the gasifier train utilized in the present invention maintains the syngas temperature at 1000° F. or above. Accordingly, in these embodiments, it may be feasible to preserve volatiles rather than destroying them because they do not condense. The benefits of the maintenance of volatiles include the resulting density of syngas in relation to the syngas from conventional airblown gasifiers, which typically also includes carbon monoxide, hydrogen, nitrogen, and steam. In some embodiments, the volatiles are maintained above their condensation temperature in the entire gasification system, until they are burned in the gas turbine. In some embodiments, the syngas produced in accordance with the present invention has a density of about 300 BTU/SCF. Higher density of syngas can equate, for example, to smaller equipment needed to gasify, cool or clean the syngas.

As used herein, the articles “a” and “an” mean “one or more” or “at least one,” unless otherwise indicated. That is, reference to any element of the present invention by the indefinite article “a” or “an” does not exclude the possibility that more than one of the element is present.

In some embodiments, hybrid IGCC plants of the present invention are designed to operate without carbon capture and storage (CCS) at the outset, as sequestration systems are not yet available. In some embodiments, the use of CCS in connection with the present invention may lead to the reduction of CO₂ emissions from coal plants by over 90%. In some embodiments, the hybrid IGCC plants of the present invention are carbon-ready, and accordingly can minimize the cost of carbon capture when compared with post-combustion scrubbing. Upgrading the invention to CCS can, for example, be paid for by the savings of exemplary hybrid IGCC plants of the invention relative to the next-cheapest alternative plants. This can minimize or eliminate the impact of carbon caps or rate hikes to pay for CCS, once sequestration becomes available. Such effects would make new technology regarding CCS more acceptable in societies concerned about global warming but unwilling to fund costly endeavors to minimize or prevent it.

Without wishing to be bound by any particular theory, it is believed that, in retrofit applications, a 20-35% reduction in CO₂ emissions is realized by the higher plant efficiency relative to that of existing steamplants in developed countries and by as much as 45% relative to that of existing steamplants in developing countries. In some embodiments, the CO₂ emissions of the hybrid IGCCs of the present invention can be reduced to below the level that a new gas turbine combined cycle plant might achieve, making it an attractive alternative to gas plants in the near-term, even before carbon sequestration systems are available.

### Overview

In some embodiments, the invention includes the same major elements as those of any other IGCC: a gasification system feeding a combined-cycle plant. For example, exemplary gasification systems include a pressurized gasification train, including a pressurized carbonizer, pressurized syngas cooler, and pressurized syngas cleanup system. Exemplary combined cycle plants include a gas turbine and a heat recovery steam generator (HRSG). The HRSG may be an existing PC plant, a newly built HRSG, or in some cases, a combination of an existing steamplant and a new HRSG. As a hybrid, exemplary IGCC plants of the present invention produce char that is fed to an existing PC plant.

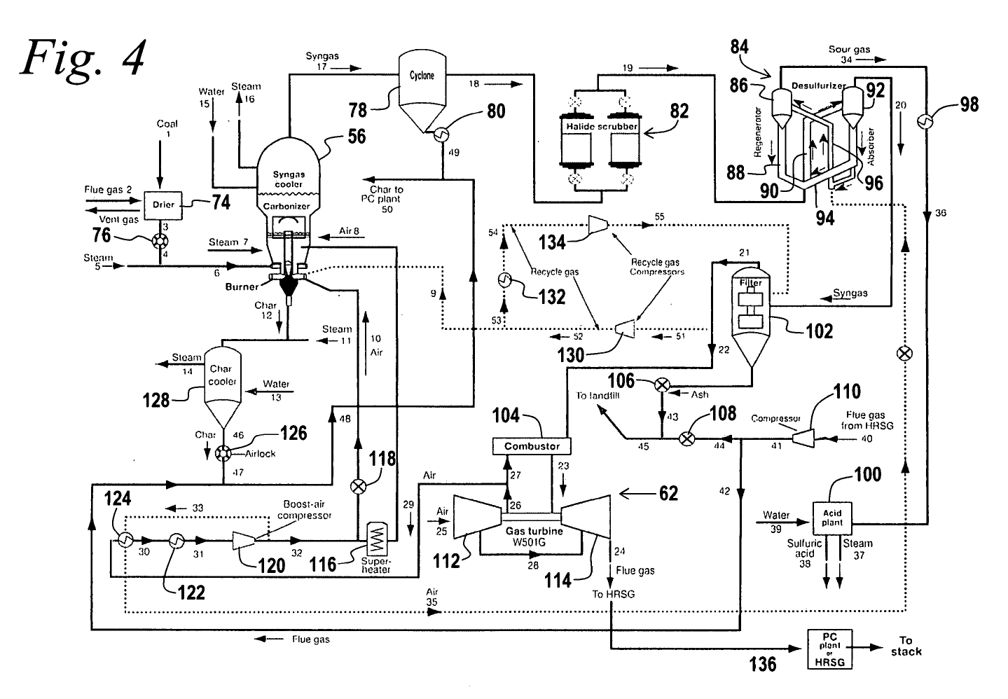

An exemplary process flow sheet for the invention is shown in FIG. 4. The carbonizer is fed coal, steam, and air to produce syngas. The syngas is cooled by coolant tubes in a fluidized-bed cooler located, e.g., in the upper region of the carbonizer's pressure vessel.

The syngas leaving the carbonizer flows through a cyclone, which removes char fines, cools them, and conveys them to the PC plant. The syngas then flows through the warm-gas cleanup system, including a halide scrubber, desulfurizer, and high-temperature filter. The desulfurizer includes a regenerator, whose exhaust stream fed to an acid plant to produce sulfuric acid. The cleaned syngas leaves the filter and is burned in the gas turbine's combustor. Steam is added at the combustor to increase output and reduce NOx emissions. Some of the syngas can be used as “recycle gas,” i.e., can be fed to the external burners of the carbonizer and to clean the elements in the high temperature filters.

The excess char is removed from the carbonizer through a cooler and airlock. From there, it is conveyed to the retrofitted PC plant, pulverized, and cleaned, and burned. The existing steam plant's burners have been modified to burn char instead of coal. If the existing boiler is to be used as the HRSG, the excess air in the gas turbine's flue gas may be used to burn the char. The flue gas is ducted to the existing boiler through insulated pipes after passing, if necessary or desired, through a cooler.

The air for gasification, operating the external burners and the desulfurizer regenerator, comes from the gas turbine's compressor. Boost-compressors are used to pressurize the recycle-gas, bleed air, and flue gases that are used for pneumatic conveying. A superheater is used to preheat the air and steam used to gasify char.

### The Carbonizer

In some aspects, the hybrid IGCCs of the present invention utilize a carbonizer. In some embodiments, the carbonizer forms a syngas. In some embodiments, the carbonizer utilized in the present invention is designed and operated in a way that preserves the volatile matter in coal, rather than destroying it.

In a conventional carbonizer, air is injected into the gasifier to heat the incoming flows by partial combustion. The volatiles are largely combusted by this air and the remaining tars are removed by operating the gasifier at a sufficiently high temperature to thermally crack them. In some embodiments, to avoid the destruction of the volatiles, the carbonizer utilized in the present invention heats incoming flows with external burners, whose products of combustion are oxygen-free. The air injected into the carbonizer utilized in the present invention to help gasify char is isolated from the volatiles by an internal separator, referred to herein as the “draft tube”. Without wishing to be bound by any particular theory, it is believed that the result is that the airflow required for gasification and to heat the incoming flows is reduced by about ⅔, and the volumetric flow rate of the syngas, by about a half. This reduces the size and cost of the equipment in the gasification train accordingly.

In some embodiments, the present invention includes a fluidized bed carbonizer. An exemplary fluidized bed carbonizer 56 is shown in FIG. 5. An exemplary carbonizer consists of pressure vessel 139 that has an interior region fed by a jet, in which the flow is upwards, and an outer annulus 140 of hot fluidized char. Fluidization is caused by steam and air injected through a distributor plate 142 at the bottom of the annulus, which also gasifies char, producing water-gas. The flow of solids around the bed begins with the entrainment of char by the gases in the jet, continues with their deflection by deflector 152 back onto the annulus, and ends with their downward flow through the annulus to complete the loop.

The incoming flows (of coal, air, and steam) are heated by external combustion. In some embodiments, this is provided as an array of burners 144 mounted radially on the perimeter of the carbonizer. The burners are used to keep the carbonizer at its design temperature by heating char particles as they become entrained by flow from the burners. A central pipe (“draft tube” 150) promotes the upward flow. The tops of the burners are just underneath the opening in the draft tube. Alternatively, a single vertical combustor could be mounted a controlled distance under the inlet of the draft tube.

In some embodiments, the airflow to the external burners is controlled to burn the recycle-gases to completion, forming CO₂. Burning carbon to completion uses only half the air that is needed in conventional air blown gasifiers, which produce CO. Preserving the volatiles also reduces the energy required for producing the syngas, as pyrolysis is less energy-intensive than gasification. Altogether, the airflow to the carbonizer of the invention is only 30% that of a conventional air blown gasifier. (See, e.g., FIG. 26.)

In some embodiments, the present invention includes a spouted bed fluidized bed carbonizer. A fluidized bed gasifier with central jet to promote circulation is referred to as a “spouted bed”. In some embodiments, a spouted reactor is used in connection with the present invention because it excels at keeping the entire volume in the reactor mixed—a quality known as “global mixing”. For example, global mixing may occur in reactors as large as 15 ft in diameter, the size of reactor which can be utilized in connection with the present invention, e.g., to feed a 400-MW power plant from a single vessel.

In some embodiments, the spouted bed uses a draft tube. The use of draft tubes in spouted beds is unusual. They have been successfully tested, however, in a full-scale (cold model) carbonizer. The draft tube promotes circulation, and also preserves the volatiles by isolating them from the air in the annulus. The flow through the draft tube is in dilute phase, so its pressure drop is low compared with the pressure at the bottom of the fluidized bed. This promotes char circulation, which in turn further helps keep the char temperatures uniform throughout the carbonizer. The mixing avoids the occurrence of hot spots which could clinker the ash, or cold regions in which the gasification would be too slow.

In some embodiments, the flow rate of the steam and air injected into the bottom of the annulus is metered to provide the desired amount of water-gas. The heat created by the exothermal reaction (of air reacting with char, forming carbon monoxide) may be modified such that it equals the heat required by the endothermic reaction (steam plus char forming hydrogen). The water-gas may pass through the char, and emerge from the top of the carbonizer (e.g., with the volatiles). In some embodiments, the nitrogen from the air remains mixed with the syngas.

In some embodiments, the air and steam are injected into a plenum 148 at the bottom of the char bed, and enter the bed through bubble caps 170 in the plenum's top surface.

In some embodiments, excess char may be removed from the carbonizer via the hopper at its bottom, at a rate determined by steam (11) pressure on the “L” valve 146. The char rate may be controlled, e.g., by a level sensor at the side of the carbonizer, so the top of the bed is at the same altitude as the top of the draft tube. Bottom-removal of the char may, for example, reduce or eliminate the possibility of a buildup of oversize particles in the char bed that might otherwise defluidize the bed. From the “L” valve, the char may then pass through the char cooler, which is cooled by steam tubes, before being depressurized through an airlock and transported to the PC plant.

In some embodiments, to operate the carbonizer, the unit is started with the annulus filled with char, by turning on the external burners and fluidizing flows. Circulation, as well as heating of the char, may begin immediately. When the bed has reached its operating temperature, coal 6 may be fed through a coal feed pipe 147 into the bottom of the draft tube. The coal particles may be enveloped, and quickly heated, by a high flow of circulating char. The volatiles may then be released by the heat, and flow out of the top of the draft tube along with the circulating char and newly-devolatized coal.

In some embodiments, the pyrolysis of the coal will be largely completed by the time the particles leave the draft tube. To the extent that more reaction time is needed, pyrolysis may be further accomplished or completed in the upper region of the char bed.

### The Syngas Cooler

In some embodiments, the IGCCs of the present invention include a syngas cooler. The syngas cooler 138 may be a fluidized bed with imbedded coolant tubes that is located, e.g., in the upper region of the carbonizer pressure vessel. Coolant 15 can enter the coolant tubes, and leave as coolant 16. The fluidized bed may be mounted on a distributor 154 that allows the syngas to pass through it. The fluidized bed 156 may, for example, be made up of low-silica granules. In some embodiments, there is no feed to or from the bed other than the material (e.g., low-silica granules) that may be required from time to time to maintain a constant inventory of free-flowing material. In some embodiments, the syngas cooler is mounted within the carbonizer vessel, which eliminates the need for the high-maintenance, high-temperature conduits between carbonizer and cooler that would otherwise be required.

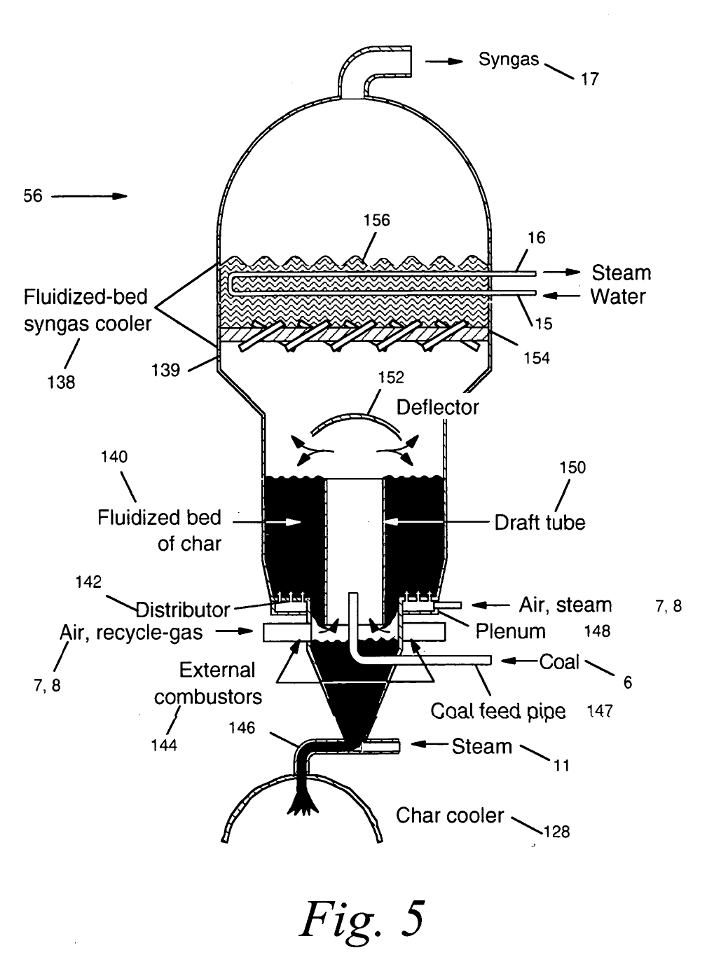

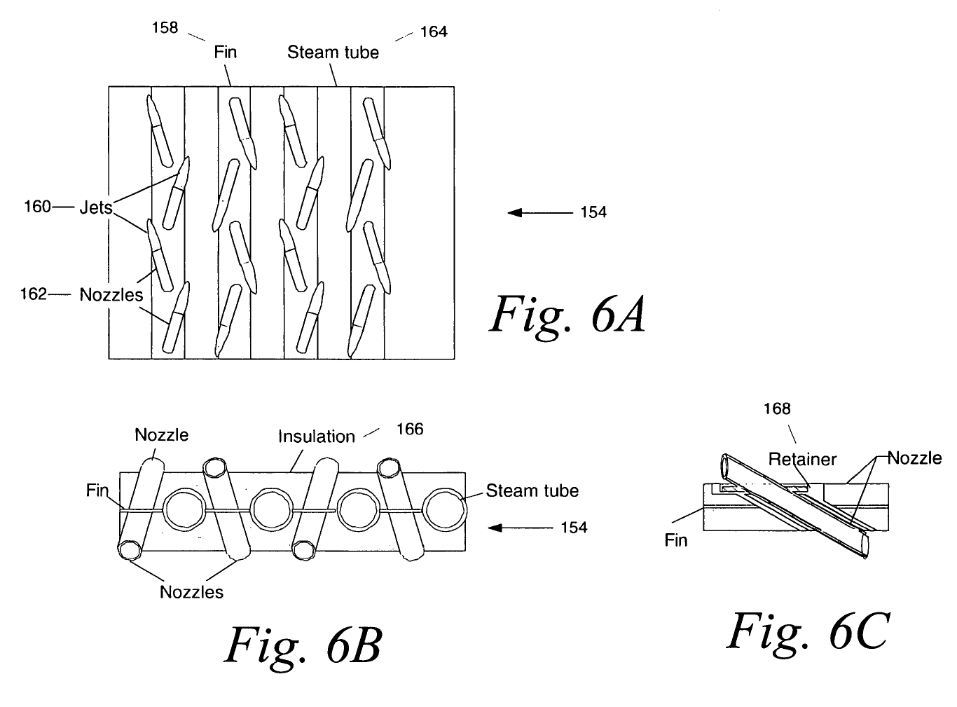

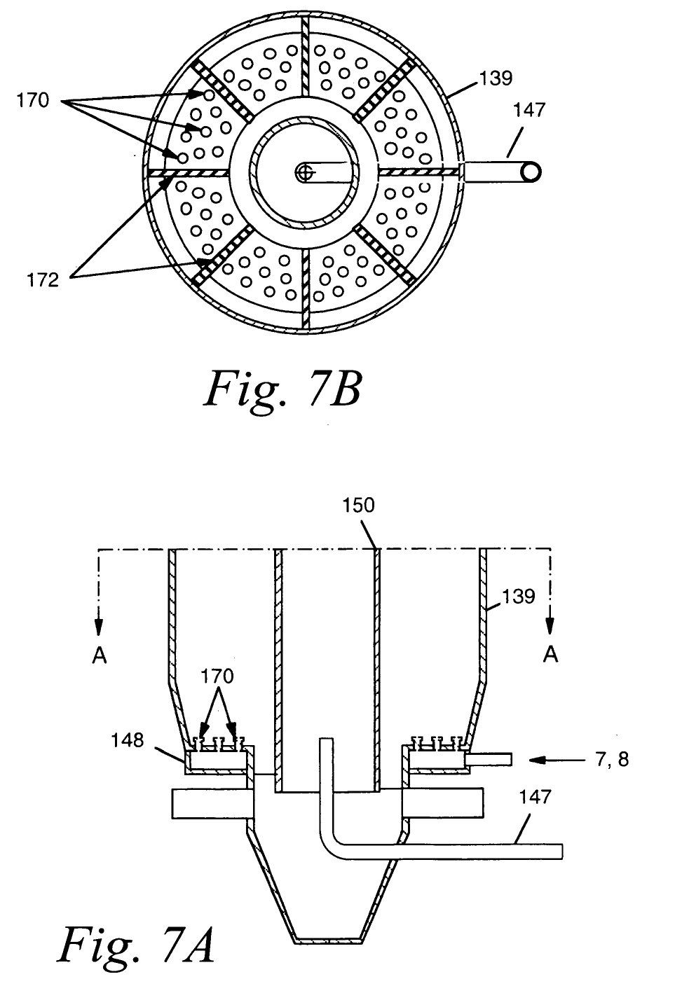

In some embodiments, the present invention includes a distributor plate. An exemplary distributor plate is shown in FIG. 6. The distributor may consist of an array of slanted tubes or nozzles 162, whose angle relative to the horizontal is less than the angle of repose of the bed material. Such a configuration may hinder or prevent weepage of the material during shutdown. Without wishing to be bound by any particular theory, it is believed that since the flow through the tubes is straight, there is little or no buildup by particulates in the syngas. Such a buildup may occur in conventional bubble caps, where there is change of direction of the gases. The tubes may be mounted on a fin-tube array, which are welded assemblies of fins 158 and tubes 164. Coolant flowing through the tubes can keep the plate cooled and structurally intact. The tube assembly may be insulated from the bed and surrounding gases by insulation 166. The tubes may also be insulated from the fin-tube assembly to avoid condensation of the tars. In some embodiments, the design and effectiveness at avoiding fouling are the same or similar as those described in dual-bed fluidized-bed combustors.

In some embodiments, the fluidized-bed cooler has higher heat transfer coefficients, lower syngas flow rates, and/or a lower syngas temperature difference than the water-tube heat exchangers used in conventional systems. As a result, in some embodiments, the fluidized-bed cooler is less than a tenth of the size of the water-tube heat exchangers used in conventional systems. (See, e.g., FIG. 18). Boiler feedwater may be used as the coolant, as its low temperature further reduces the cooling piping required. The feedwater may boil in the in-bed pipes, and its outlet temperature can be controlled by adjusting the feedwater flow rate.

In some embodiments, a conventional syngas cooler, e.g., a firetube boiler, is not utilized in the present invention because the volatile condensation can cause tar buildups. Accordingly, in some embodiments, the turbulence of the fluidized bed keeps buildups from occurring.

### The Syngas Cyclone

In some embodiments, the present invention includes a syngas cyclone. Some char may be emitted from the carbonizer, particularly at higher levels of gasification. Unlike fly ash, most of the char is coarse enough to be captured in a cyclone 78. The cyclone catch 49 may be cooled in cooler 80 then combined with the char 47 leaving the char cooler. The two streams may then be conveyed to the PC plant through a convey line 50.

### The Halide Scrubber

In some embodiments, the present invention includes a halide scrubber. The halide scrubber 82 may remove hydrogen chloride and other halides. In some embodiments, the halide scrubber is comprised of two 100%-capacity pressure vessels, each packed with a pebble bed of nahcolite or trona, minerals whose active ingredient is sodium bicarbonate. One vessel may normally be in service, with a nominal service period of two months. The second vessel may be purged, cooled, drained of spent bed material, and recharged. The vessels can be any size suitable for a halide scrubber, for example, 5, 10, 15 or 20 feet in diameter and 10, 20, 30 or 40 feet high. In some embodiments, the vessels are approximately 13 ft in diameter and about 25 ft high. The vessels may be fabricated of any material suitable for a halide scrubber, for example, carbon steel, with an inner lining of a stabilized grade of stainless steel and a refractory lining.

### The Transport Desulfurizer

In some embodiments, the present invention includes a transport desulfurizer. The transport desulfurizer 84 may use, for example, a reactor design typically used in oil refineries. In some embodiments, the transport desulfurizer consists of an absorber loop, in which the sulfur compounds in the syngas are absorbed (e.g., by particles of a zinc-based sorbent), and a regenerator loop, which restores the sorbent. The sorbent may be converted into zinc sulfide in the absorber, and back into zinc oxide in the regenerator.

Each loop may consist of a riser (90 and 96, respectively), a cyclone (86 and 92, respectively), and dipleg 88 and 94 respectively). The sorbent may be injected with the incoming gases into the bottom of each riser, separated at the cyclone and re-injected at the bottom of the dipleg. The risers may operate in a relatively dilute state, with a void fraction of about 95%. About 10% of the sorbent flowing through the absorber may continuously be circulated through the regenerator, and, in some embodiments, only about 10% of the active ingredient of a sorbent particle is reacted before it is regenerated. In some embodiments, these conditions result in capture efficiencies of more than about 95%, e.g., more than about 96%, 97%, 98%, 99%, or even 99.95%.

In some embodiments, absorption occurs at about the same temperature as the rest of the WGCU, although the reactions in the regeneration are exothermic. Accordingly, in some embodiments, the gases in the WGCU reach about 1300° F., e.g., about 1400° F., or about 1500° F. In certain embodiments, the gases in the WGCU reach about 1400° F. The gases leaving the regenerator may contain sulfur dioxide, and are then cooled in cooler 98 before being sent to the acid plant 100.

### The Acid Plant.

In some embodiments, the present invention includes an acid plant. The acid plant converts the sulfur dioxide in the regenerator gas into sulfuric acid. Unlike plants which make elemental sulfur, acid plants produce significant amounts of steam. The steam may be produced in a succession of catalytic reactions as the sulfur dioxide is converted into SO₃, e.g., at about 800° F. The steam 37 may be captured and reused, further improving the efficiency of the present invention. In some embodiments, an alternative to the acid plant 100, a Claus unit, which produces elemental sulfur instead of sulfuric acid, is utilized in the present invention.

### Metallic Candle Filters

In some embodiments, the present invention includes metallic candle filters. Metallic candle filters 102 are arrays of porous structures used to remove the fly ash and spalled sorbent. In some embodiments, individual filters are constructed of layers of alloy screens that have then been sintered. The resulting thick-walled construction may result in extraordinarily high collection efficiencies. Operated like baghouses or fabric filters, the filters can be cleaned by high-pressure pulses of recycle-gas 55 that breaks loose the filter cake on their surface, dropping it into a bin for removal. Self-acting valves on each filter element can automatically isolate it in case it springs a leak. The valves may be sufficiently fast-acting to avoid turbine blade damage, should it occur.

### The Gas Turbine

In some embodiments, the present invention includes a gas turbine. Gas turbines originally developed to serve as natural gas combined cycle powerplants (NGCCs) may be used for IGCCs. The capacity and turbine inlet temperature of gas turbines has been increasing since they were introduced in the 1960's, which has increased their efficiencies while lowering the per-kW cost. The gas turbine 62 used in the calculations used to describe the performance of the invention is based on the Siemens model SGT6-6000G, formerly the Siemens-Westinghouse W501G.

In some embodiments, the gas turbines used with syngas in connection with the present invention can be operated without modification. In other embodiments, gas turbines are modified. For example, gas turbines can be modified by opening up the flow passages through the inlet vanes of the expander to accommodate the higher volumetric flow rate of syngas. This may increase the stall margin and reduce the danger of flameout. Gas turbines operating with syngas may have a higher flow rate and power output than turbines operating on natural gas. In some cases, this may approach the torque limits of the turbine shaft.

In some embodiments using syngas, the combustor, which is normally of a pre-mix design with natural gas (to minimize NOx emissions), must be nozzle-mix (or, diffusion design) with syngas to avoid flashback due to the hydrogen in the syngas. In some embodiments, even diffusion burners can meet the NOx standards being established for IGCCs (15 ppmv). Some gas turbines may be subject to hot corrosion by the moisture formed by hydrogen in the syngas. In some embodiments, the gas turbine utilized in the present invention is adapted such that it is not subject to hot corrosion by the moisture formed by hydrogen in the syngas.

Gas turbines operating on syngas may encounter flameout when its heating value is too low, and the syngas from conventional air blown systems sometimes approaches this limit. In some embodiments, the syngas produced by the present invention has a heating value high enough to avoid flameout. In some embodiments, the syngas produced by the present invention has a heating value of about 300 BTU/SCF.

### Auxiliary Systems

The present invention may include one or more auxiliary compressors. In some embodiments, boost-air compressor 120 and recycle-gas compressors 130 and 134 are utilized to overcome the pressure drop through the gasifier train. Coolers 120, 122, and 132 upstream of the compressors may be used to increase efficiency and reduce their costs. In some embodiments, no cooler is used ahead of the first recycle-gas compressor, to avoid tar deposits. A flue-gas compressor 110 may also be used to pneumatically convey the char to the PC plant. The flue gas may come, e.g., from the HRSG's or steamplant's stack.

The present invention may include one or more heat exchangers. In some embodiments, the principal heat exchangers 128, 138 and 244 recover heat from the char and syngas. A significant amount of heat exchange may also occur in the acid plant 100.

In some embodiments, the waste heat is recycled to heat flows entering the gasifier, such as through superheater 116. Without wishing to be bound by any particular theory, it is believed that using waste heat to preheat flows to the carbonizer provides the highest conversion efficiency, and also reduces the external burner fuel requirement—in turn reducing the airflow to the gasifier and the corresponding syngas flow rate. In some embodiments, the syngas cooler 244 is used to superheat the compressor discharge air 27 from the gas turbine. In some embodiments, the coal is dried and preheated, e.g., as seen in FIG. 8.

In some embodiments, the airflow to the external burners is not superheated, in order to minimize NOx emissions. In further embodiments, the coolant for the syngas cooler 58 is steam, not air, because there may not be enough space available for air tubes in the fluidized-bed cooler 138.

The present invention may further include a char cooler. In some embodiments, the char cooler 128 is a pressure vessel containing a moving-bed heat exchanger. For example, in some embodiments, the char particles cascade across heat exchanger piping, and are kept in free-fall by having the material from the vessel's bottom be removed more quickly than it is fed, which keeps the heat exchanger from filling. In some embodiments, heat transfer is in counter flow, with the water 13 entering at the bottom of the cooler and superheated steam 14 leaving at the top.

Additional components may be employed in the hybrid IGCCs of the present invention without departing from the scope of the invention.

### Exemplary Fuels of the Present Invention

The present invention is suited for all grades of coal, as well as biomass. In some embodiments, however, the present invention is not suited to using either petroleum coke (which may be too unreactive) or municipal solid waste (which may be too heterogeneous to fluidize).

Fuels for which the hybrid IGCCs of the invention is suited include, but are not limited to: bituminous coal, sub-bituminous coal, brown coal, lignite, clinkering, high-ash coals and biomass.

Bituminous and sub-bituminous coals require no special processes for their use. However, the rank of the coal does affect the equipment size and operating conditions. As reactivity of coal diminishes with increasing rank, the lower-rank coals are preferable if very high levels of gasification are required. Also, the higher the rank of the coal, the lower is the coal's volatiles content, which means that more gasification is required, This in turn increases the cross-sectional area of the char bed 140.

The high moisture (upwards of 60% by weight) and sodium content of brown coal (or lignite) may require special treatment. Conventional driers that use only heat are undesirable as they are both fuel-intensive and costly. In some embodiments, steam fluidized bed drying (SFBD), developed by the German firm RWE in the 1980s, is utilized in treating brown coal or lignite. SFBD has been described as a heat pump in reverse. The most recent version is called “Fine-grained WTA”. WTAs dry the coal to relatively low moisture levels (as low as 12%) and use very little energy (12.2 kW/kg/s of raw coal).

In fluidized-bed gasifiers firing lignites and biomass, both of which are generally high in sodium, the sodium combines with silicates in the ash to form clinkers. To avoid this, the fluidized-bed temperature of conventional air blown gasifiers has had be reduced to as low as 1400° F., resulting in unacceptably low carbon conversion rates—as low as 75%. In the conventional gasifiers, the particles in the bed are mostly ash, which is the component that is subject to clinkering. In a carbonizer, the carbon-to-ash ratio is many times higher, which can reduce the tendency to clinkering because the carbon is not sticky.

However, the particles downstream of the carbonizer have higher concentrations of ash. The short residence time of the particles downstream may inhibit buildups. However, if clinkering does occur, finely-divided kaolinite and/or calcite powder may be injected into the carbonizer's freeboard to serve as “getters” for the sodium. These powders are then collected with the fly ash at the filter. The powders can be used on a once-through basis, as they themselves may become sticky otherwise.

In the syngas coolers of oxygen-blown IGCCs, cooling losses are so severe that oxygen-blown gasifiers are unsuited for high-ash coals. In this regard, the invention is the best-suited of any IGCC for high-ash coals because it can minimize both the temperature drop and the mass-flow through the syngas cooler. However, the amount of ash in char going to the existing PC plant is significantly greater than the coal it replaces, because upwards of 40% of its heating value has been removed in the draft tube.

Conventionally-produced biomass, such as wood or switchgrass, is several times costlier than coal. However, since it avoids the need for sequestration it would be more competitive than it is now, once carbon-caps are mandated. A key benefit of biomass is that could provide a long-term alternative to coal, or in countries with biomass but no or little coal. Only minimal modifications would be required—primarily in the fuel feed system, and the clinkering-prevention measures described above—to make biomass usable in plants originally designed to burn coal.

### Turndown

Turndown is a major issue in powerplants of all types, insofar as storing electricity is generally impractical. Conventional steamplants can be modulated to as little as 20% of their rated capacity with little change in efficiency, but the efficiency of gas turbines of combined cycle plants drops quickly with a reduction of throughput. This in turn requires the use of gas turbine peaking plants which, however, use the costlier fuels and are less efficient.

In some embodiments, hybrid IGCCs of the present invention can provide turndown and yet maintain high efficiency by simultaneously reducing the coal feedrate and increasing the gasification rate. The fuel energy to the gas turbine thereby may remain constant while the char fed to the PC plant and its power production are reduced.

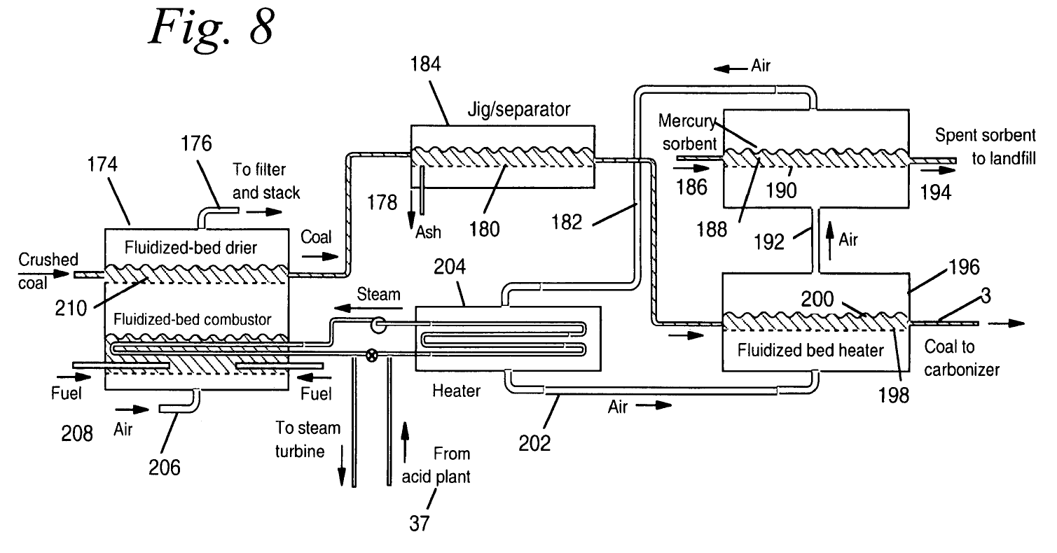

To implement this, the annular bed in the invention's carbonizer may be comprised of a series of separated arc-shaped segments that are formed by radial separators 172 in FIG. 7. The segments created by the separators may be individually fluidized according to power requirements. At full load, some of the segments may be left on standby as the maximum amount of the syngas is produced by pyrolysis in the draft tube. As the load drops, an increasing number of the standby segments may be turned on. FIG. 7 shows the segments to be of equal size, but for finer control, they may be made of different sizes. The segments in standby may be periodically turned on by briefly by injecting air into them, to maintain their temperature near the carbonizer's design point.

### Mercury

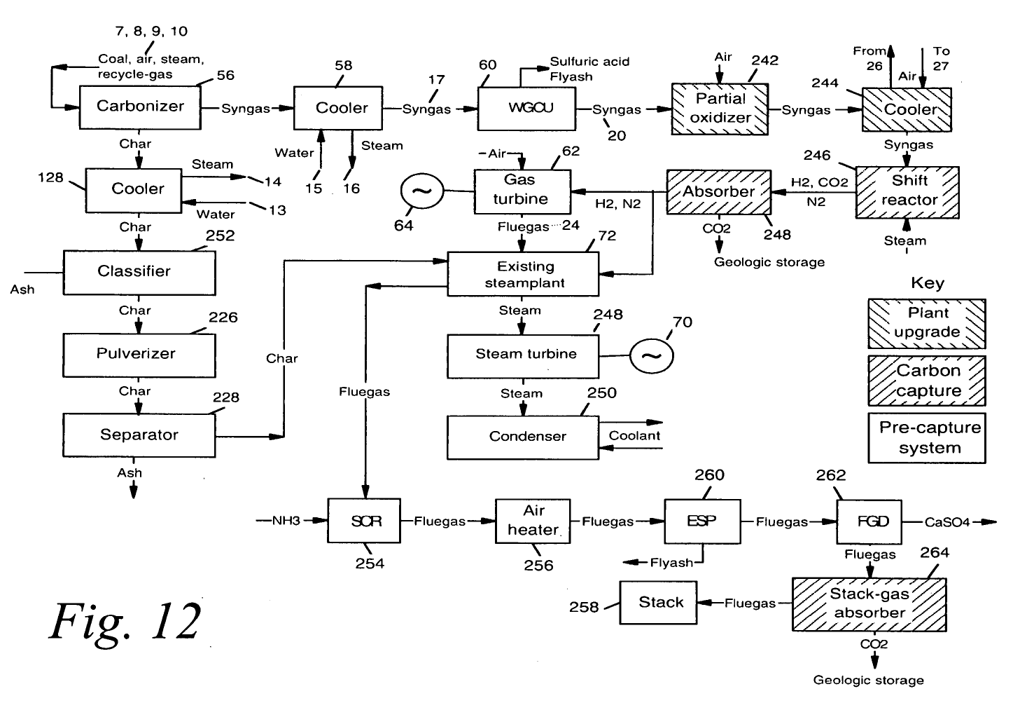

The technology used in conventional IGCCs to remove mercury uses a low-temperature process that may be unavailable for use in the present invention because it requires that the syngas be below the tar condensation temperature. Accordingly, in some embodiments, the present invention provides for the co-benefit capture of mercury using a selective catalytic reactor (SCR), fabric filters or electrostatic precipitator (ESP), and/or flue-gas desulfurizer (FGD) at the PC plant's stack. (See, e.g., FIG. 12). In some embodiments, e.g., embodiments using SCR, ESP and/or FGD, the mercury capture of the present invention removes about 90% of the mercury without special or additional treatment. An alternative or supplement is to inject chemically-treated activated carbon into the boiler's flue gas, ahead of its stack 258. Because many coal plants produce only a few pounds of mercury per year, this may be a viable option. The cost can be reduced further by using the char produced by the invention, as the char from air blown gasifiers is nearly as reactive as the char used in commercial activated carbons.

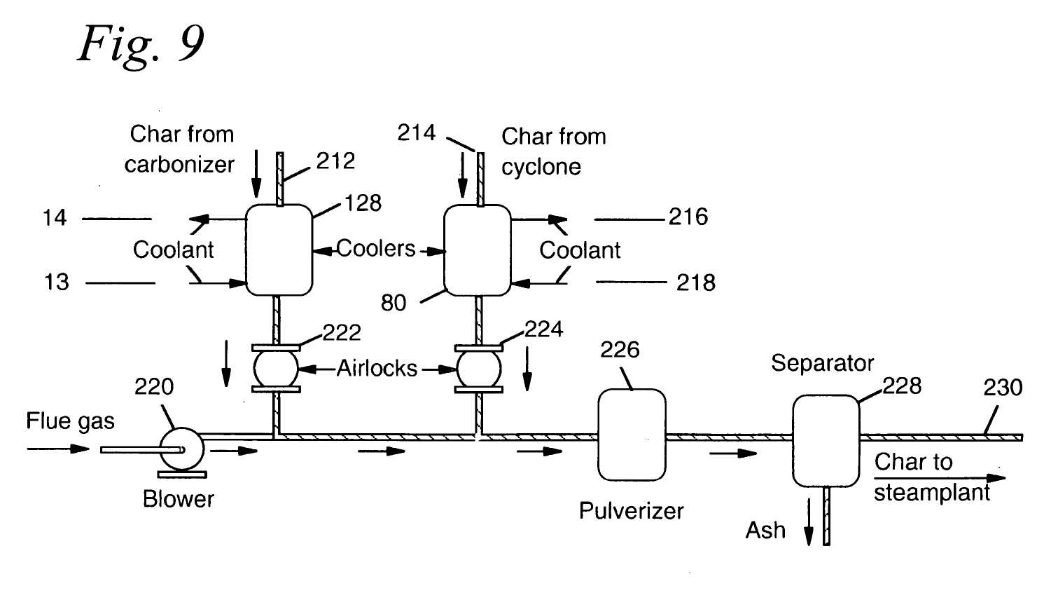

Additional options include the coal preparation system of FIG. 8, and the char preparation system of FIG. 9, which are both described in a later section.

### Exemplary Configurations of the Present Invention

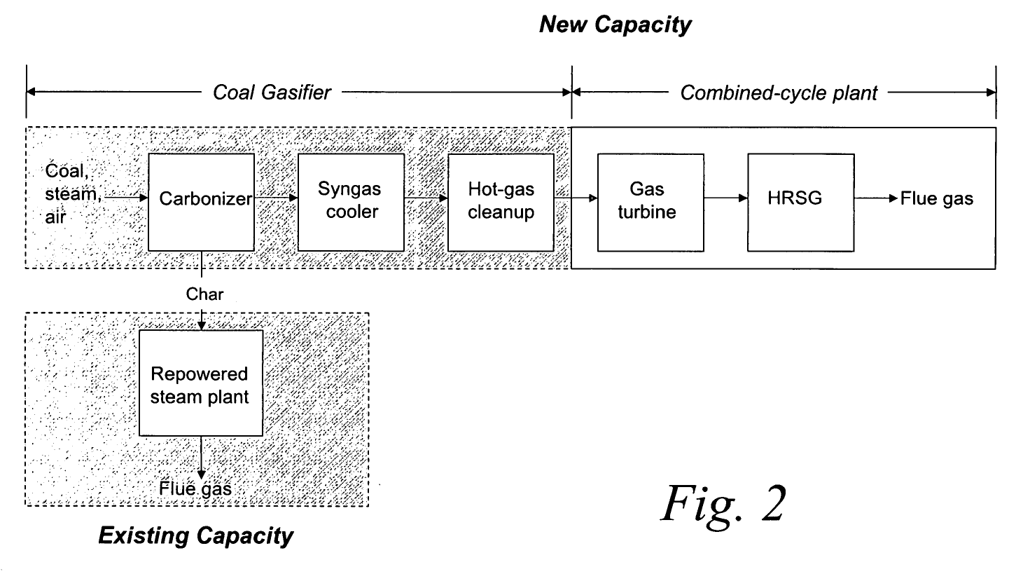

Mark 1. (See, e.g., FIG. 2). Mark 1 is the exemplary version of the invention that may be used in new installations. Mark 1 is hybrid with its own heat recovery steam generator (HRSG). While Mark 1 can be used in greenfield applications, it may also located near an existing PC plant site. Proximity can increase the convenience of transferring the char from the carbonizer to the steamplant, and allows for the sharing of other balance-of-plant equipment. In some embodiments, the cost of electricity for Mark 1 is the lowest of any configurations of the present invention, but it may also have higher CO₂ emissions and use more water than other configurations.

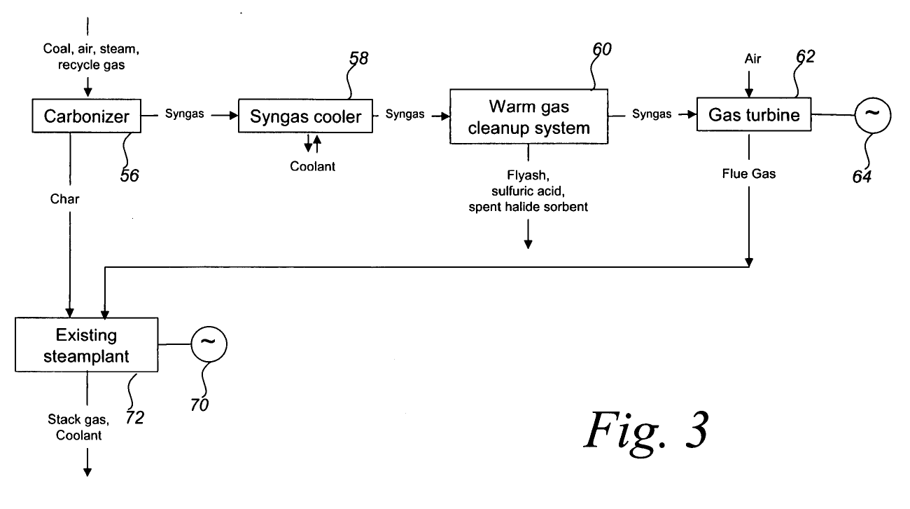

Mark 2. (See, e.g., FIG. 3). In certain embodiments of its application, the present invention is used to retrofit existing PC plants. Both the flue gas from the gas turbine 62 and the char from carbonizer 56 may be ducted to the existing steamplant 72, which serves as the HRSG. The capacity of the invention's plant, and its char flowrate to the boiler, can both be designed to match the flows and temperatures of the existing steam plant before the retrofit.

In some embodiments, such a design utilizes a gasification level of about 70%. The gasification level is defined as the percentage of energy in coal to the carbonizer that is used to produce syngas. The remaining energy in the coal may be in the char sent to the retrofitted steamplant. In some embodiments, the generating capacity of the retrofitted plant is about 260% of the capacity of the existing steamplant.

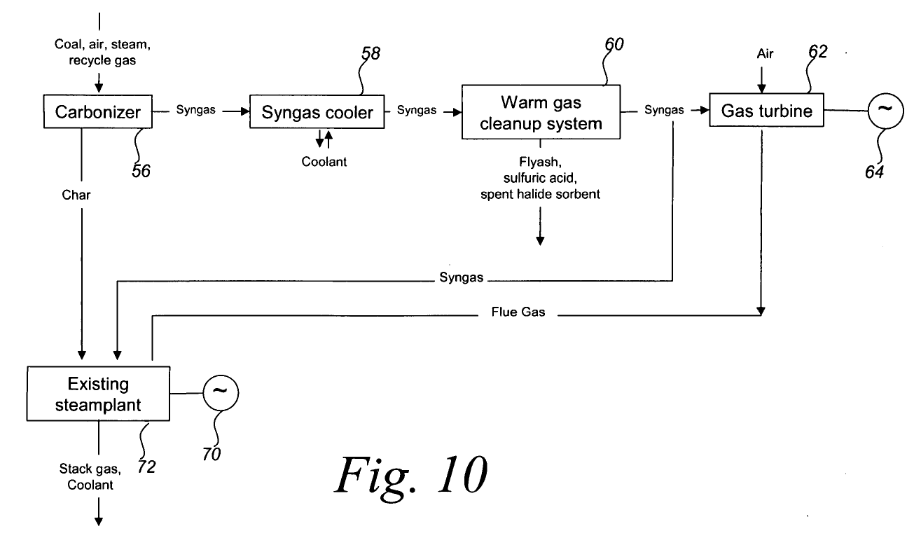

Mark 3. (See, e.g., FIG. 10). In some embodiments, e.g., in Mark 3, both syngas and char are burned in the retrofitted steamplant. In some embodiments, such a design utilizes an increased level of gasification, to as high as 80-90%, depending on the coal rank. The higher the level of gasification, the lower the excess-char flows from the carbonizer, until, at the maximum level of gasification, this flow becomes zero. The benefits of higher levels of gasification include a reduction in the concentration of ash in the boilerplant; a reduction in the unburned carbon loss from the retrofitted boiler, because there is less char being burned and because the syngas increases the combustion efficiency; replacement of auxiliary fuel with syngas for flame stabilization at low loads; and minimization of the amount of carbon dioxide that must be removed by post-combustion scrubbers in CCS application. The only downside of higher levels of gasification is that both the capacity and cost of the coal gasifier train may be increased.

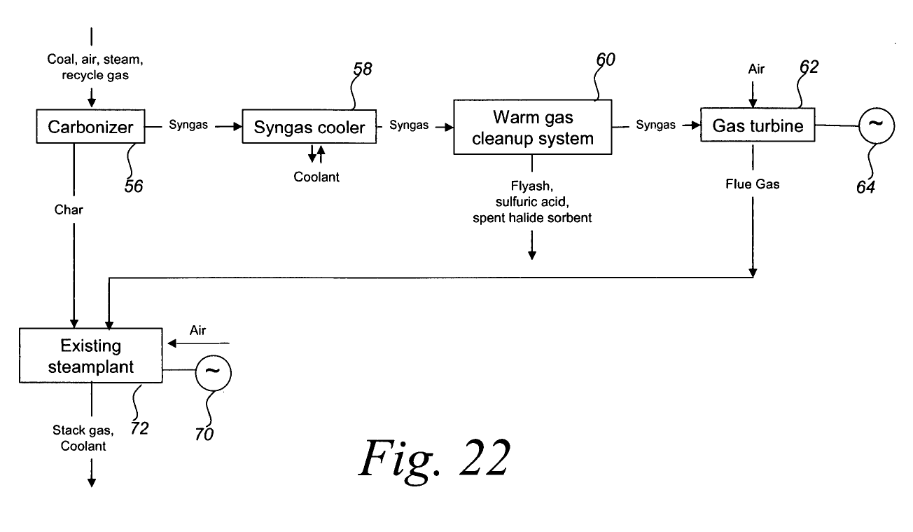

Mark 4. (See, e.g., FIG. 22). In some embodiments, e.g., in Mark 4, air is added to existing boiler 72 to supplement the air in the flue gas from the gas turbine 62 for burning the char. In some embodiments, such a design utilizes low levels of gasification, which are employed when the added generating capacity of the invention is lower than the rated plant output, which is the plant output provided by Mark 2.

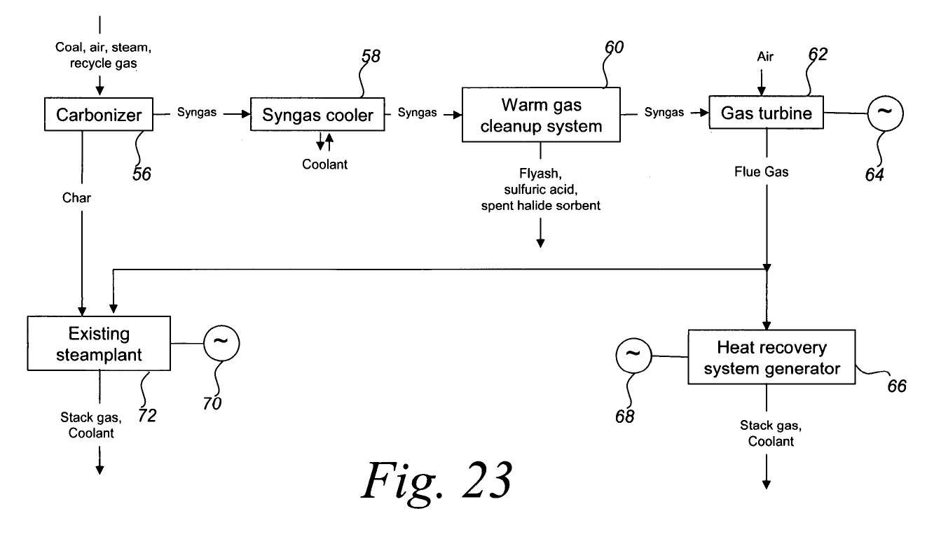

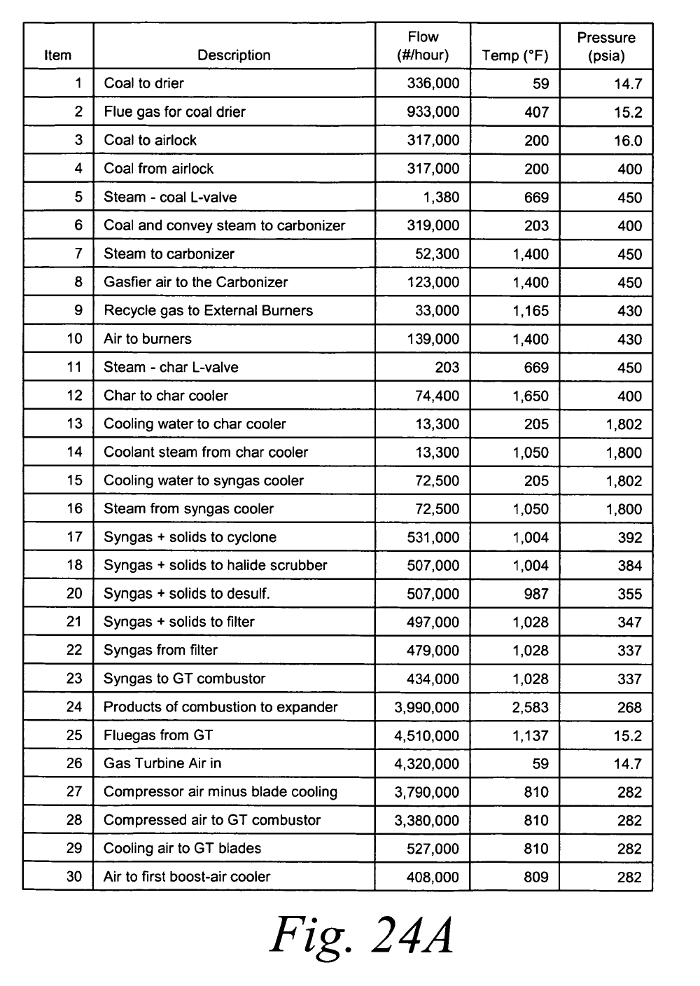

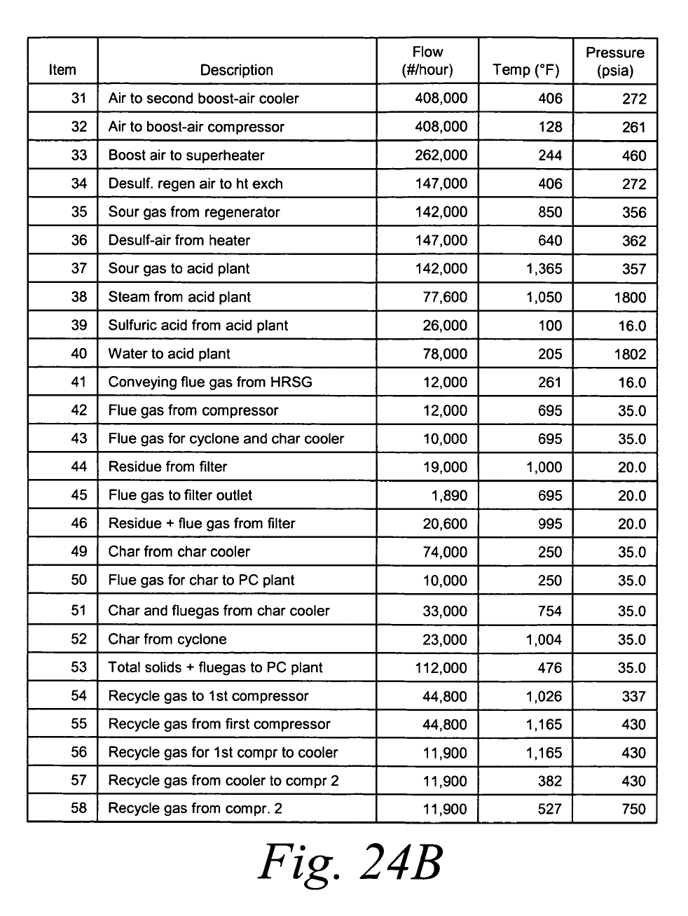

Mark 5. (See, e.g., FIG. 23). In some embodiments, e.g., in Mark 5, a HRSG 66 is added to the system, to supplement the heat recovery of the retrofitted steam plant 72. Embodiments such as Mark 5 may be used, for example, when the additional power required by the powerplant of the invention is greater than that of Mark 2.

### Upgrading for Carbon Capture and Storage (CCS).

In some embodiments, the hybrid IGCC plants of the invention are carbon-ready, which means that they can be modified to provide CCS. The goal of the upgrades is to reduce the CO₂ emissions of the retrofitted steamplants. In some embodiments, the CO₂ emissions of the retrofitted steamplants are reduced by over 50%, e.g., over 60%, 70%, 80%, or 90%. In certain embodiments, the CO₂ emissions of the retrofitted steamplants are reduced by over 90%. The reduction may be from both the efficiency gains provided by the invention and from its CCS.

In some embodiments, the pre-combustion carbon capture systems of hybrid IGCC plants of the present invention remove the CO₂ more cheaply than stack-gas systems. This may, for example, be due to high pressure and concentration in the scrubber. In the some embodiments, the hybrid IGCC plants of the present invention uses pre-combustion carbon capture for removing 70 to 90% of the CO₂. The balance is removed by a stack-gas scrubbers at the existing steamplant.

There are a number of configuration options, and some criteria used for selecting among them include, but are not limited to, minimizing the equipment changes required during upgrading, minimizing the preliminary investment needed to be carbon-ready, retaining the original benefits of the non-CCS version of the technology, and reducing the methane in the syngas to a level consistent with the required level of CO₂ reduction.

FIG. 12 is a schematic representation of a hybrid IGCC plant configuration which includes a CCS. The upgraded powerplant may use mature technology (shift reactors 246 and absorption systems 248) for first converting the syngas to a mixture of hydrogen, carbon dioxide and nitrogen. The absorbers may then separate the CO₂ from the hydrogen/nitrogen mixture. The hydrogen/nitrogen mixture may be used as fuel for the gas turbine 62, while the CO₂ is dried, pressurized, and sequestered, such as in geological storage. If pure hydrogen is required, a second separator can be used to remove the nitrogen.

During an upgrade, the only additional equipment, beyond that needed for any CCS system, may be a partial oxidizer 242 and its syngas cooler 244. The partial oxidizer acts as a pressurized furnace, while the syngas cooler is a pressurized heat exchanger.

In some embodiments, the partial oxidizer converts the tars into a mixture of char and gases, and a portion of the methane into carbon monoxide and water vapor. Its operating temperature may be controlled by the incoming airflow. The temperature can be chosen based upon what is required to reduce both the tars and the methane to acceptable levels. The syngas cooler 244 downstream of the partial oxidizer may return the syngas to the temperature required by the shift reactor. Since this heat can be recycled into the gas turbine's discharge air, partial combustion should have only a minor effect on plant efficiency.

The nitrogen mixed in with the hydrogen in the syngas can increase the size and cost of the shift reactor and absorption units as compared with an oxygen-blown carbonizer. Accordingly, in some embodiments, the carbonizer 56 utilized in the present invention is operated with oxygen to avoid complications caused by the nitrogen. On the other hand, the nitrogen in the syngas increases the power throughput of the gas turbine, thereby reducing the need for steam to fill the expander, while also reducing NOx emissions. Accordingly, in some embodiments, oxygen-blown IGCCs of the present invention re-inject the nitrogen back into the gas turbine. The use of air may also eliminate the cost and efficiency penalties of the oxygen plant.

An alternative configuration provides for the injection of air alone through the carbonizer external burners 144, instead of the products of combustion from burned recycle-gas. This would already burn off some of the volatiles, reducing the air and heat required in the partial oxidizer. To offset this, the throughflow capacity of the warm-gas cleanup system may be enlarged.

FIG. 12 also depicts a train of scrubbers downstream of the existing steam plant, which may be utilized in the present invention. Although they are not necessary for the invention to reduce CO₂ emissions, their presence may further reduce emissions (as in existing plants).

### Ash Concentration in the Steamplant.

The ash concentration in the char fed to the retrofitted steam plant is typically 40% greater than the coal it replaces. With low-ash coals such as Australian lignites that contain only 1% ash, the effect on operation is negligible. At the other extreme, with high-ash coals such as some in India and China, the higher ash in the char may make it incombustible in a pulverized coal boiler. Even at moderate levels of ash, increasing the ash concentration will require the enlargement of both the ash disposal system and the stack-gas particulate collector.

Simple solutions, if available, include washing the coal, blending it with a coal having a lower ash content, or using a lower-ash coal. Accordingly, in some embodiments, coal employed in the present invention is washed or blended with a coal having a lower ash content. In other embodiments, a low-ash coal is utilized in the present invention. Another partial solution is the coal jig, or separator, in the coal preparation system (FIG. 8) and the separator in the char preparation system (FIG. 9), both described below.

Additional separation of the ash from char can be provided by the classifier 252 upstream of pulverizer 226, or, preferably, by separator 228 downstream of the pulverizer. A complete solution is to use Mark 3 (FIG. 10), to increase the level of gasification, and transmit enough syngas to return the fuel passing through the PC plant to the original ash concentration.

In all likelihood, the least-costly solution will be a combination of more than one of these methods.

### Coal Preparation System

In some embodiments, the hybrid IGCC of the present invention includes a coal preparation system. See, e.g., FIG. 8. The coal preparation system depicted in FIG. 8 uses a process being developed by the Western Research Institute (WRI) called precombustion thermal treatment of coal (PCTTC). The benefits of PCTTC include the removal 50-80% of the mercury in coal in its first stage, depending on the type of coal, and perhaps half of the remainder, in the coal jig downstream of the heater. Mercury removal was the original purpose of the PCTTC system. The benefits of PCTTC can also include the reduction of the amount of ash going to the boilerplant and the reduction of the heating requirements of the carbonizer external burners, which in turn provides a reduction in the syngas volumetric flowrate, equipment costs, and an increase in plant efficiency. PCTTCs may also provide a convenient system for burning the unburned carbon in the fly ash in the effluent from both the high-temperature filter 102 and the existing boilerplant's ESP 260 as well as a convenient source of superheat for the low-temperature steam generated at the acid plant 100.

In operation, the PCTTC system dries the coal at temperatures between 250° and 300° F. in an atmospheric drier 210, then heats it to 550° F. in fluidized-bed heater 196 to release the mercury from the organic part of coal. Circulating “sweep” air leaving the coal heater may pass through a second bed 188, where a high-temperature sorbent removes the mercury, and is then recycled to the heater.

The principal fuel for the fluidized bed combustor may be the carbon in the fly ash collected from both the gasifier train filter 102 of the IGCC plant and the boilerplant's electrostatic precipitator 260. In some embodiments, coal is used to supplement this principle fuel. Accordingly, the fluidized bed combustor may increase the plant's carbon utilization, while rendering the fly ash into a saleable low-carbon supplement for cement manufacture.

### Char Preparation Plant

In some embodiments, the hybrid IGCC of the present invention includes a char preparation system. See, e.g., FIG. 9. In some embodiments, the final stage of ash removal is the separator 228 downstream of the pulverizer at the retrofitted steamplant. Either a magnetic separator or an electrostatic separator or both may be used to remove ash. Without wishing to be bound by any particular theory, it is believed that, for high-ash coals with finely-imbedded ash, the collection efficiency is highest here, insofar as the coal is more finely divided than anywhere else in the system.

In some embodiments, the electromagnetic separator works on the paramagnetic mineral pyrrhotite (FeSx), which has been transformed from the non-magnetic pyrites in coal by the heat of the carbonizer. In some embodiments, because much of the remaining mercury is contained in the pyrites, there is a possibility that this, too, can be removed at the separator.

The pulverizer 226 in the char preparation plant may be used to maximize the carbon utilization in the boiler by minimizing the particle size. Char formed under pressure, which occurs in hybrid IGCCs, is sometimes less reactive than the char formed in a pulverized coal plant, resulting in lower carbon utilization in the retrofitted boilerplant. On the other hand, if the char is formed in an inert (i.e., non-oxidizing) atmosphere, even under pressure its reactivity is about the same as that of a PC boiler. In some embodiments, the region where pyrolysis occurs (e.g., the draft tube 150) is kept air-free and thus pyrolysis occurs in an inert atmosphere.

Char is more friable than coal, so the particles emerging from the pulverizer will be smaller. Accordingly, in some embodiments, the use of a char preparation plant will enhance carbon burnout. The carbon remaining in the fly ash leaving the boilerplant may be burned in the lower bed of the fluidized-bed combustor 174 contained in the coal-preparation plant.

### In-Bed Desulfurizer

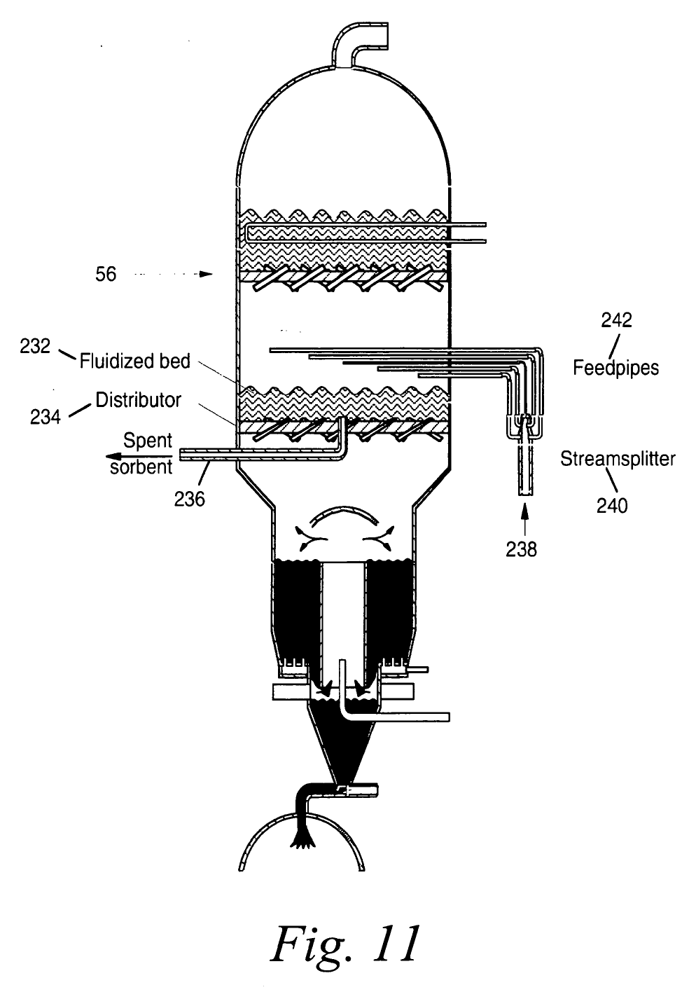

In some embodiments, the hybrid IGCC of the present invention includes an in-bed desulfurizer. See, e.g., FIG. 11. An alternative method of desulfurizing may be the use of a fluidized-bed of calcium carbonate mineral such as limestone or dolomite. In such method, the calcium carbonate may be calcined by the bed temperature into calcium oxide and carbon dioxide.

Because, a fluidized bed may not be as efficient as the transport desulfurizer, a transport desulfurizer may be used as well. However, use of the fluidized bed reduces the desulfurizing airflow 35 substantially. This in turn reduces the steam required to fill the expander, and overall, the plant efficiency rises by 1-2%. The spent sorbent is processed by a sulfator, in which the sorbent (as CaS) is converted to calcium sulfate in an oxidizing atmosphere. The sorbent leaving the sulfator is suitable for landfill, and may also be used as an ingredient in concrete.

### Spray Cooler

An alternative to the fluidized-bed syngas cooler 138 is a spray cooler, whereby the syngas is cooled in a chamber into which water is sprayed. Depending on the water requirements of the gas turbine, this may reduce the plant efficiency.

### Microprocessor

In some embodiments, the present invention includes a microprocessor programmed to operate one or more functions of a hybrid IGCC of the present invention. Accordingly, in some embodiments, the microprocessor is programmed to maintain the syngas at a temperature above a tar condensation temperature of a volatile matter in the syngas until the syngas is burned in the gas turbine. In some embodiments, the present invention is directed to a plant which includes a microprocessor programmed to maintain the syngas at a temperature above a tar condensation temperature of a volatile matter in the syngas until the syngas is burned in the gas turbine.

### Performance

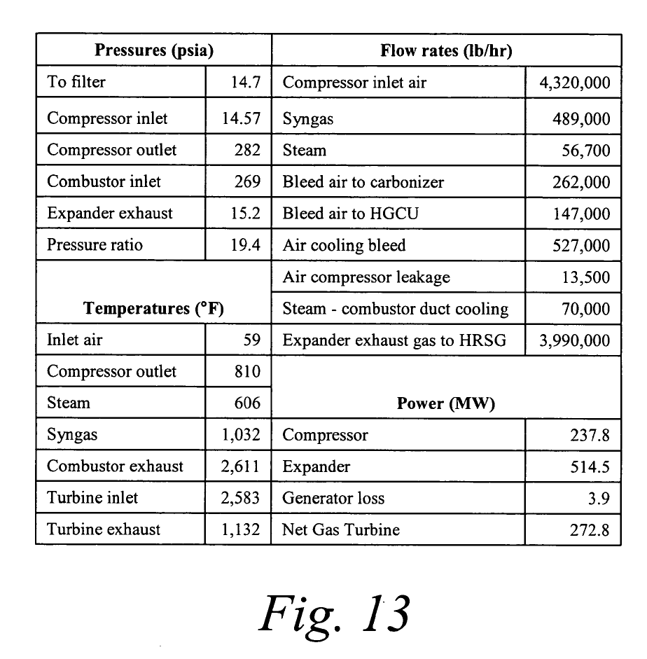

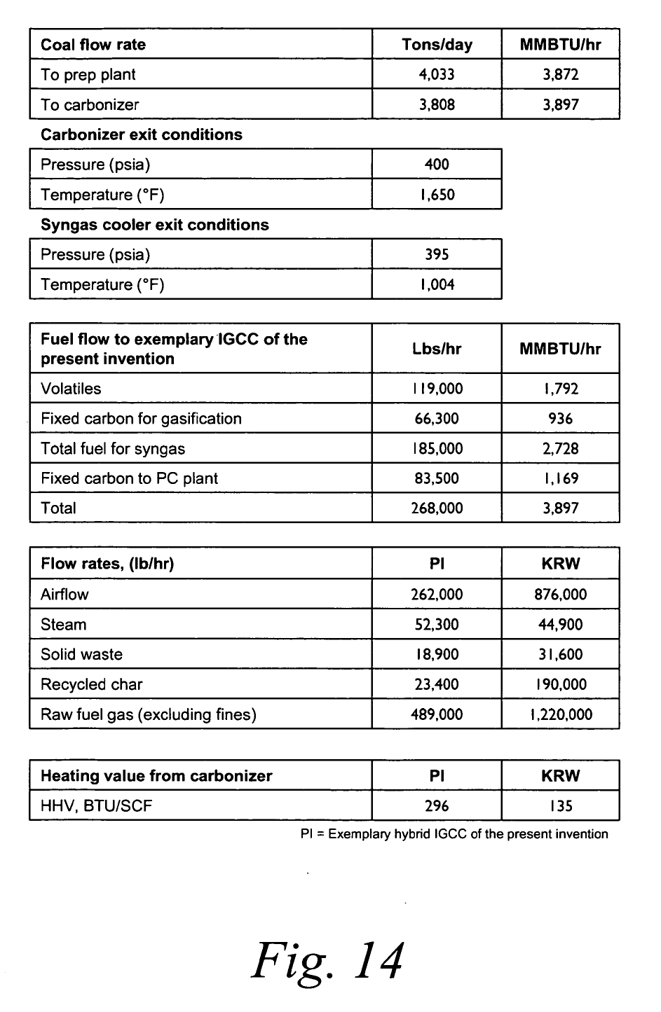

FIG. 13 describes the operating conditions of an exemplary gas turbine and FIG. 14 describes the conditions in an exemplary carbonizer in accordance with the present invention.

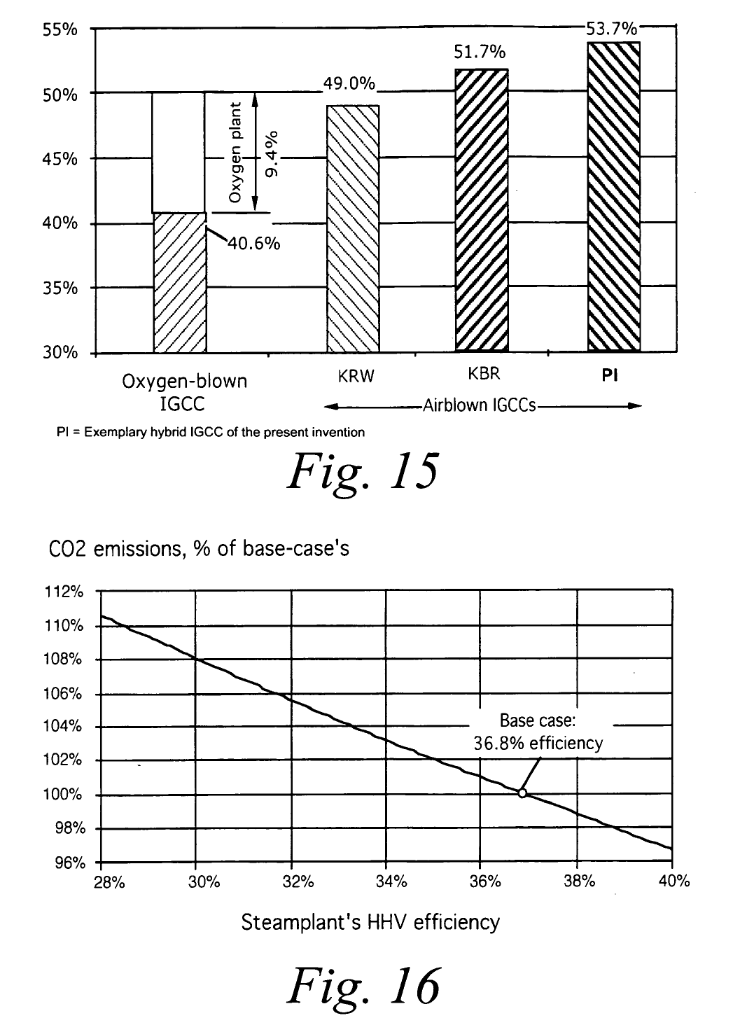

In some embodiments, the efficiency of hybrid IGCCs is significantly higher than that of any other current technology. The plant efficiency of the invention (see, e.g., FIG. 15) may be somewhat higher than that of the other air blown systems. In some embodiments, the invention requires less airflow to its carbonizer, which reduces the losses associated with the syngas cooler, as well as the auxiliary power required for the compressors.

In some embodiments, e.g., in retrofit applications, the efficiency of the existing steamplant affects the efficiency of the combined system (see, e.g., FIG. 16). The base-case steamplant in FIG. 16, with an HHV efficiency of 36.8%, uses a subcritical steam cycle with three stages of turbines. The inlet conditions for the HP, IP, and LP turbines, respectively, are: 1800 psia×1050° F.; 342 psia×1050° F.; 342 psia/485° F.

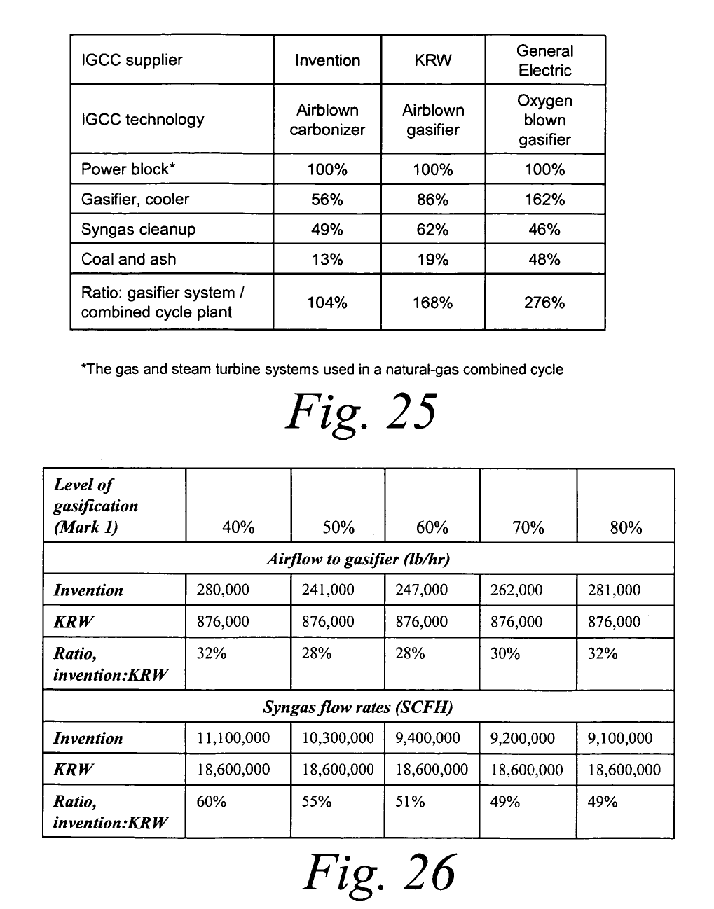

In some embodiments, the present invention achieves low capital cost. The gasification system of the invention may, for example, cost only about the same as the power block, which brings its total capital cost below that of a new pulverized coal plant. As seen in FIG. 25, the cost of conventional IGCCs do not allow them to be competitive with conventional PC plants. In some embodiments, the present invention provides low capital cost, combined with high efficiency and low cost of coal. This combination may make the cost of electricity produced in accordance with the present invention 25-30% lower than that of a PC plant, the next-cheapest source.

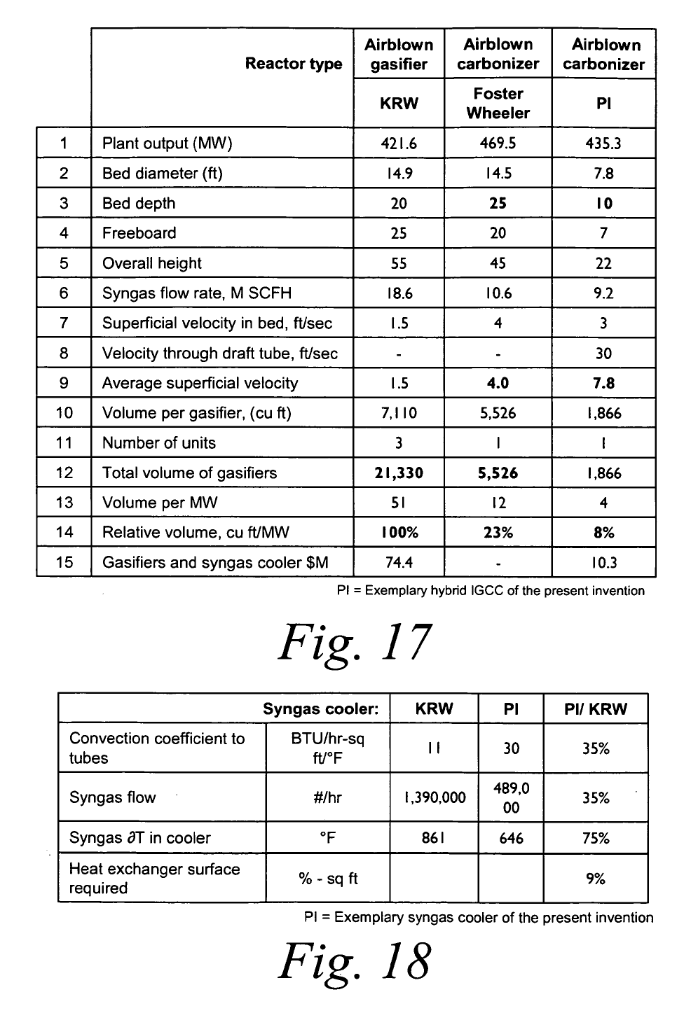

In some embodiments, a large portion (e.g., over half) of the cost savings realized by the invention, relative to other IGCCs, comes from the reduced size of both the gasifier (FIG. 17) and the syngas cooler (FIG. 18). FIG. 17 describes the size and operating parameters of three designs or gasifiers or carbonizers supplying syngas to similarly-rated IGCCs.

In some embodiments, a large portion of the size reduction by hybrid IGCCs is due the difference between the size of gasifier and carbonizer. This may be due to the need of the former to gasify the char fines, but not the latter. The conventional carbonizer (middle column) may be larger than the carbonizer of the invention (right-hand column) for two reasons. The conventional carbonizer typically needs a deeper char bed in order to thermally crack the volatiles (see FIG. 17, row 3). Additionally, the velocity in the draft tube of the carbonizer of the invention (see FIG. 17, row 8) may be much higher than the superficial velocity in a fluidized bed, resulting in twice the average velocity through the carbonizer of the invention (see FIG. 17, row 9). Accordingly, in some embodiments, the carbonizer that is less than 10% the size of a conventional air blown gasifier.

In some embodiments, the syngas cooler of the invention is also smaller (e.g., tenfold smaller) than conventional coolers. The heat transfer coefficient to the cooling tubes, for example, may be much higher in a fluidized-bed than in the convection of the firetube heat exchanger of a conventional cooler. Moreover, the syngas flowrate in connection with the present invention may be less than, e.g., only half, that of the conventional air blown gasifier IGCC. Additionally, the bed temperature may be higher in conventional gasifiers to thermally crack the volatiles, which increases heat exchanger size.

In some embodiments, the present invention utilizes external combustion. Use of external combustion may reduce the airflow to the carbonizer by 70%, and the syngas volumetric by half, compared with a conventional air blown IGCC. (See, e.g., FIG. 26). This, in turn, may reduce the size of the gasifier train, including the warm-gas cleanup system, by the same amount. Together, the cost of capital in connection with the present invention, as well as the cost of electricity, may be 30-40% lower than those of an air blown IGCC, and 25-30% less than that of a conventional PC plant.

With regard to air emissions, the concentration of particulates in the stack of an IGCC in accordance with the present invention are about the same as the most stringent ambient air pollution standards (30 μg/cu M). See, e.g., FIG. 19. In some embodiments, the sulfur dioxide emissions are also one to two orders of magnitude lower than those of a conventional coal-fired powerplant, when fitted with sulfur scrubbers.

In some embodiments, the present invention meets existing NOx air pollution standards. In some embodiments, improved combustor design may further lower NOx emissions, or selective catalytic reactors (SCR), as in FIG. 12, may be used to reduce NOx emissions by up to an additional 80%.

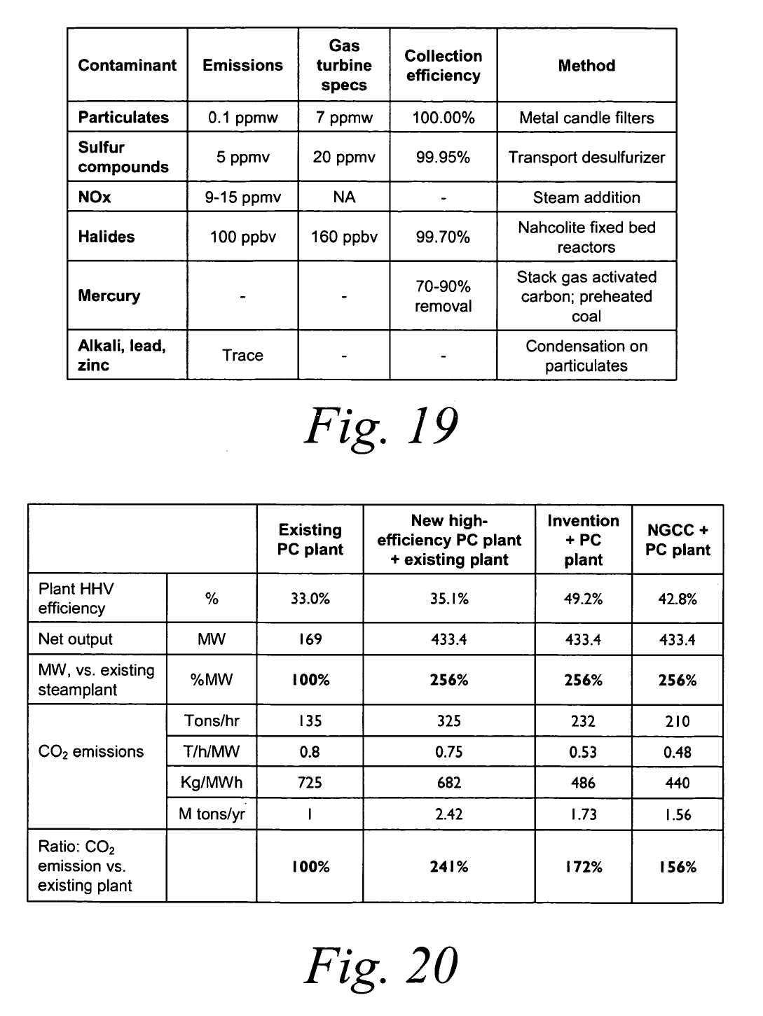

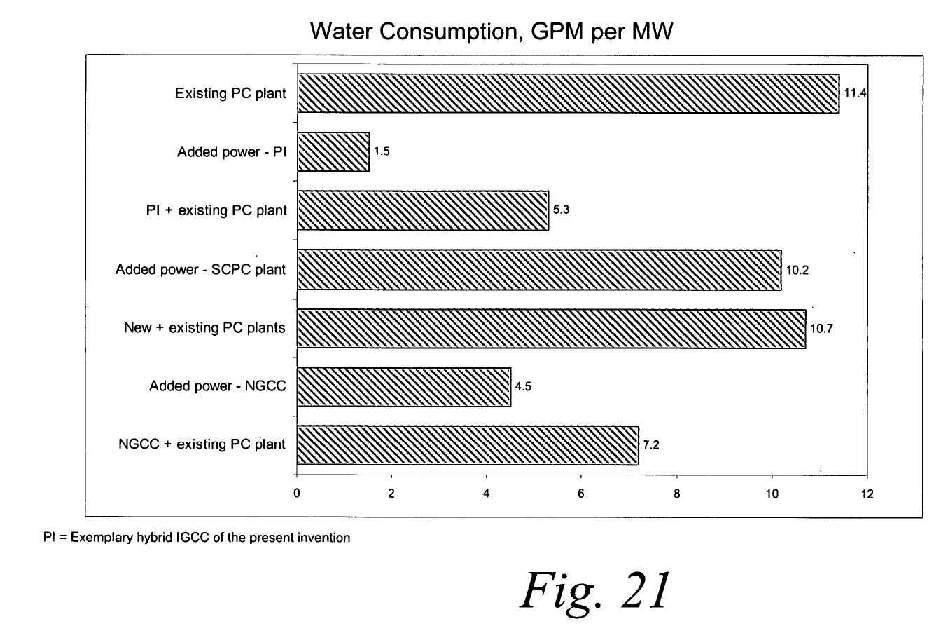

In some embodiments, the hybrid IGCCs of the present invention provide increased efficiency over conventional power plants. FIG. 20 describes the efficiency of exemplary IGCCs of the present invention in comparison to other plants. As seen in FIG. 20, a steamplant retrofitted with a hybrid IGCC in accordance with the invention emits only half as much additional CO₂ as if a new coal plant were built instead (increases of emissions by 72% vs. 141%). However, the emissions from the retrofitted plant are estimated about 10% more than if a natural-gas-fired combined-cycle plant were built instead. The emissions from the new plant using the invention can be reduced by the 10% amount (or more) by de-rating the facility. This may be done by either by building a full-scale plant and operating it at 90% of full capacity, or building a slightly smaller unit, and operating the steamplant at 90% of capacity. Accordingly, in some embodiments, this will enable new coalplants to meet a common requirement in developed countries—CO₂ emissions not exceeding those of a natural gas plant of equal capacity.

The benefits of coal plants over gas plants, even before CCS is available, include the cost of coal-fired electricity versus natural-gas-fired power and the affordability of potential CCS systems in IGCC retrofit versus natural gas plants. A natural-gas-fired combined cycle plant still emits 60% as much CO₂ as a new IGCC using the invention (Mark 1). With the invention, the savings pay for the CCS, but with NGCC plants, there are no such savings. Therefore, these plants are likely to remain uncontrolled, with regard to CO₂, for a longer time.

Steamplants require massive amounts of coolant to condense the spent steam, but the gas turbines of the IGCCs do not use any cooling water. (See, e.g., FIG. 21). In some embodiments, the hybrid IGCC of the present invention still requires some water, principally for gasification and to add to the expander, however, the net increase in water consumption is much smaller than with alternative technologies.

1. A hybrid integrated gasification combined cycle (IGCC) plant, the hybrid IGCC comprising:
a carbonizer that forms a syngas;
a syngas cooler;
a warm gas cleanup system; and
a gas turbine fired by the syngas,
wherein the carbonizer is comprised of a draft tube surrounded by a fluidized bed of char, in which solid fuel to said carbonizer is injected in an upward direction into said draft tube, and said char in said fluidized bed is both fluidized and gasified by the addition of steam and air into the bottom of said char bed.

2. The hybrid IGCC plant of claim 1, wherein said solid fuel is coal.

3. The hybrid IGCC plant of claim 1, wherein the heat bringing the incoming flows to the carbonizer is provided by external combustion.

4. The hybrid IGCC plant of claim 1, wherein a char from the hybrid plant is burned in a steamplant.

5. (canceled)

6. (canceled)

7. (canceled)

8. The hybrid IGCC plant of claim 3, wherein a heat recovery steam generator supplements the heat recovery of said steamplant.

9. (canceled)

10. (canceled)

11. The hybrid IGCC plant of claim 1, wherein the syngas cooler comprises a fluidized bed containing coolant tubes.

12. (canceled)

13. The hybrid IGCC plant of claim 2, wherein the coal is dried and heated before being injected into the carbonizer, using a precombustion thermal treatment of coal (PCTTC) system.

14. The hybrid IGCC plant of claim 13, comprising a coal dryer, the dryer comprising an atmospheric-pressure dual-stage fluidized bed combustor, wherein combustion occurs in a lower fluidized bed, the lower fluidized bed incorporating coolant tubes to maintain its temperature below a fusion temperature of the ash in the fuel, and wherein one or more products of combustion from the lower fluidized bed pass through a distributor plate overhead and into a second fluidized bed, the second fluidized bed containing the coal being dried.

15. (canceled)

16. The hybrid IGCC plant of claim 1, wherein the syngas cooler comprises a distributor plate comprising a plurality of slanted openings in a refractory assembly supported by internal coolant tubes, wherein the slanted tubes are mounted on a slant sufficient to eliminate the weepage of a bed material when the IGCC plant is not operating.

17. (canceled)

18. The hybrid IGCC plant of claim 1, wherein a fluidized bed of particulates containing calcium carbonate is injected above a carbonizer bed in the carbonizer.

19. The hybrid IGCC plant of claim 4, wherein said char is pulverized, and the pulverized char is passed through a separator, in order to remove fine particles of ash, and wherein the separator employs either magnetic forces or electrostatic forces, or both, to separate the ash from the char.

20. The hybrid IGCC plant of claim 1, wherein only said char that is burned is the char fines contained in said syngas.

21. A method of retrofitting an existing steamplant comprising the step of retrofitting an existing IGCC plant according to claim 1.

22. (canceled)

23. (canceled)

24. (canceled)

25. A method of removing mercury from coal, the method comprising treating coal in a precombustion thermal treatment of coal (PCTTC) system that comprises an atmospheric-pressure dual-stage fluidized bed combustor, wherein combustion occurs in a lower fluidized bed, the lower fluidized bed incorporating coolant tubes to maintain its temperature below a fusion temperature of the ash in the fuel, and wherein one or more products of combustion from the lower fluidized bed pass through a distributor plate overhead and into a second fluidized bed, the second fluidized bed containing the coal being dried.

26. (canceled)

27. The hybrid IGCC of claim 20, wherein said carbonizer is operated at conditions that minimize the emission of said char fines, without significantly enlarging or complicating said carbonizer to achieve this.
